(19) United States
(12) Patent Application Publication
(10) Pub. No.: US 2007/0100035 A1
(43) Pub. Date: May 3, 2007

(54) Paint with color change additive and method of application and painted substrate

(76) Inventors: George S. Rosekelly, Norwalk, OH (US); Brian Roulstone, Beaconsfield (GB)

Correspondence Address: Kenneth J. Stachel, 15885 W. Sprague Road, Strongsville, OH, 44136, US

(21) Appl. No.: 11/586,905

(22) Filed: Oct. 26, 2006

Related U.S. Application Data
(63) Continuation-in-part of application No. 29/194,622, filed on Nov. 25, 2003, now abandoned.
(63) Continuation-in-part of application No. 11/005,400, filed on Dec. 6, 2004.
(60) Provisional application No. 60/527,383, filed on Dec. 5, 2003.

(51) Int. Cl. C08K 5/15

(52) U.S. Cl. 524/107; 428/411.1

(57) ABSTRACT

The present invention relates to a latex paint and more particularly to a paint containing a color change additive. The present invention in one or more embodiments provides for a latex paint including a pH sensitive color change additive, which changes the color of the paint in a certain period of time after application to allow painters to see where they have painted. One or more embodiments of these paint formulations of the present invention are formulated at pH values which allow for greater stability of the color change additive, improved shelf stability of the formulation, longer color change times after application, lower volatile content and odor, and use with existing packaging. The present invention is further directed to a method of applying a paint and painting a substrate white. The painted substrates have a multicolored surface while drying.

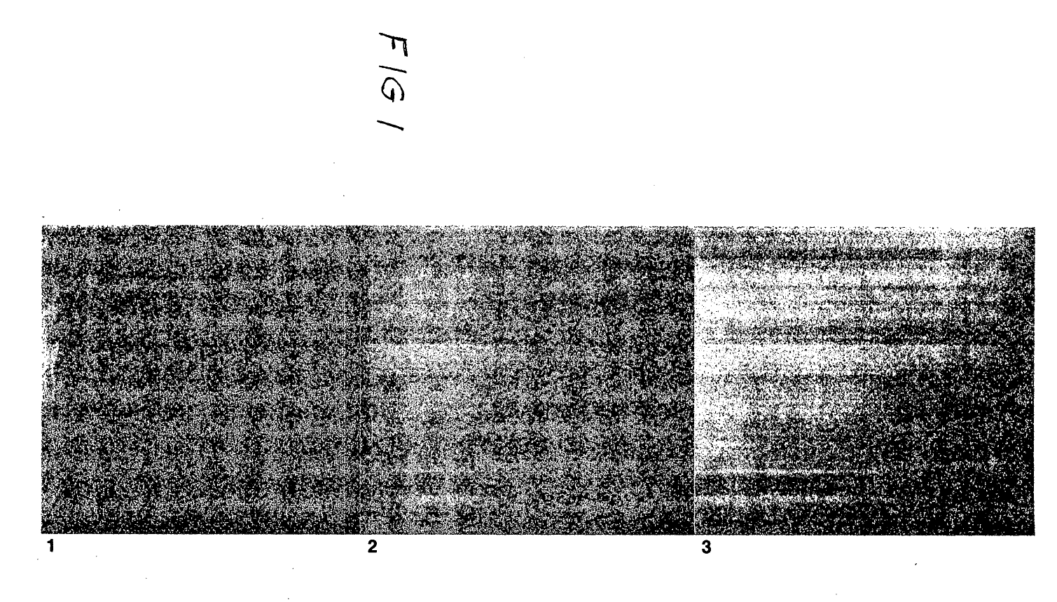

This application is a continuation-in-part of U.S. patent application Ser. No. 29/194,622 filed Nov. 25, 2003 entitled, “MULTI-COLORED TOP COAT DESIGN” and U.S. patent application Ser. No. 11/005,400 filed Dec. 6, 2004 entitled, Improved Paint with Color Change Additive and Method of Application and Painted Substrate which claims the benefit including that of priority of U.S. Provisional Patent Application Ser. No. 60/527,383, filed Dec. 5, 2003, entitled “Improved Paint With Color Change Additive and Method of Application and Painted Substrate,” the complete disclosure of all of these applications is hereby incorporated by reference.

### FIELD OF THE DISCLOSURE

The present invention relates to a paint containing a color change additive, a method of applying such a paint, and the resultant painted surface.

### TECHNOLOGY REVIEW

The application of decorative or architectural paint as thin, low viscosity, coatings to a surface or substrate can present problems for individuals applying the paint by hand held applicator, i.e., paint brush, roller, sprayer, etc. Depending on the lighting conditions, the surface being covered and the type of paint being applied, it can be difficult for the painter to determine not only the approximate thickness of the coating applied, but in some instances whether a coating has been applied in certain areas. This is a particular problem for painters when applying a similar shade of white paint over an existing coating of white paint where the lighting is poor, such as when painting a ceiling, or where shadows fall across the area to be painted. In the past, this has either forced the painter to pay particular attention to his or her work, and in some cases to remember which areas of the structure being coated were already painted. Otherwise, the structure being painted could have areas with thicker than required coating and other areas with little or no coating at all for protection.

U.S. Pat. No. 5,418,013 describes a method for decreasing the drying time of a wet coating for roof coatings by admixing said wet coating and at least one transient colorant in an amount effective to decrease the drying time, applying the admixture to a substrate, and drying the coating. For these roof surface coatings which are applied fairly thick (30 to 40 mils at a fairly high viscosity), the transient colorant may be, for example, a pH-sensitive colorant or a photobleaching colorant. Suitable colorants at this amount include phenolphthalein, thymolphthalein, cresol red, o-cresolphthalein, fluorescein, aniline blue, rhodamine B, Janus green B, Toluidine Blue O, methylene blue, Evans blue, Safranin O, rose bengal, ruthenium red, pararosaniline, and the like, and mixtures thereof. Also phenol red is used in an effective amount to dercease the drying time in Example 5.

WO 00/66508 describes a spackling compound that changes color upon the drying of the compound so a construction worker has a clear indication of when the surface is ready for performance of additional operations, i.e., sanding, taping, painting, etc. The pH of the spackling compound before drying is adjusted to between 11-13 to promote enhanced stability of the color changing component during application of the product.

European Patent Application 0 549 145 A1 to Fasano and European Patent Specification 0 488 980 to Jongerius et al describe a system where change in color is as a means to improve the wet hide capability of low cost paints (as a technique to increase the amount of extender in the paint). The higher pH's (11-13) required in such systems using phenolphthalein and thymolphthalein to stabilize the color change components used have, however, created problems not only with the shelf stability of such paints, but have also increased the corrosiveness of the paints. This forces the manufacture to require special labeling (due to potential human skin reactions), and to use containers which can handle these more corrosive paints. In addition, the higher pH paints generally require the addition of amines (to raise the pH) which creates not only additional environmental problems through the addition of volatiles, but also an odor problem for the user.

Coatings as described in the aforementioned references with pH sensitive color changing materials would not translate into useable decorative or architectual latex paints because at the lower viscosity and thickness at which the paints are applied. Use of the color changing materials as the references disclose at lower viscosity and thickness would result in coating films that change color very rapidly. It is therefore the object of the present invention among the many objects of this invention to solve these problems for the application of color change additives in paints.

### SUMMARY OF THE DISCLOSURE

One embodiment of the present disclosure relates to a paint and more particularly to a water borne paint like a latex paint containing a color change additive. The present invention in one or more embodiments provides for a paint including a pH sensitive color change additive, which changes the color of the paint in a certain period of time after application to allow painters to see where they have painted. One or more embodiments of these paint formulations of the present invention are formulated at pH values and effective amounts of at least one the color change additive to allow for greater stability of the color change additive, improved shelf stability of the formulation, longer color change times after application, lower volatile content and odor, and use with existing packaging. The present invention is further directed to a method of applying a paint.

In another embodiment, the present disclosure includes a paint composition comprising a pH sensitive color change additive wherein the paint composition has a pH of less than about 10.5 and a viscosity of less than about 65,000 centipoise.

In still another embodiment, the present disclosure includes a paint composition comprising a) a pH sensitive color change additive; and b) from about 0.001 to about 1.5% by weight of amine wherein the paint composition has a viscosity of less than about 65,000 centipoise.

In still another embodiment, the present disclosure includes a method of applying paint comprising the steps of a) applying a coating of paint composition to a surface at a thickness of less than about 10 mil comprising a pH sensitive color change additive; and b) allowing the coating of paint composition to air dry wherein the color of the paint composition changes perceptibly from about 5 minutes to about 8 hours after applying the coating to the surface.

In still another embodiment, the present disclosure includes a method of applying paint comprising the steps of a) applying a coating of paint composition having a pH of less than about 10.5 to a surface at a thickness of less than about 10 mil comprising a pH sensitive color change additive; and b) allowing the coating of paint composition to air dry.

### BRIEF DESCRIPTION OF THE DRAWING

The Figure is a color photograph of an elevational view away from the painted multicolored top coat as a painted surface pattern visible during use over ceilings or walls.

### DETAILED DESCRIPTION

Additional features and advantages of the invention will be set forth in the detailed description which follows, and in part will be readily apparent to those skilled in the art from that description or recognized by practicing the invention as described herein, including the detailed description which follows and the claims. It is to be understood that both the foregoing general description and the following detailed description are merely exemplary of the invention, and are intended to provide an overview or framework for understanding the nature and character of the invention as it is claimed.

Other than in the operating examples, or where otherwise indicated, all numbers expressing quantities of ingredients, reaction conditions, chemical properties and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The present disclosure relates to a paint and more particularly to a paint containing a color change additive, where the paints can be for example water borne or latex type paints. In this specification and claims the following terms whether in the singular, plural or possessive have the following meanings:

“aqueous-borne” and “water-borne coatings” have their art-recognised meaning which allows for the inclusion of minor amounts of co-solvents and other volatile organic material provided water constitutes more than 50%, and preferably at least 80% of the volatile phase so that even with the presence of organic solvents these coatings are still regarded as water-borne since the majority of the volatile solvent present in the liquid coating composition is water; and

“latex paint” refers to those water borne paints which are characterised in that a resinous binder is solubilized, dispersed or emulsified in an aqueous phase, commonly referred to as the continuous phase which is predominantly water. Suitable water-borne binding agents can include materials such as starch, modified starch, polyvinyl alcohol, polyvinyl acetate, polyethylene/acrylic acid copolymer, acrylic acid polymers, polyacrylate, polyacrylamide copolymers, acrylonitrile/butadiene/styrene copolymers and polyacrylonitrile.

The present disclosure in one or more embodiments provides for a paint including a pH sensitive color change additive, which changes the color of the paint a certain period of time after application to allow painters to see where they have painted. One or more embodiments of these paint formulations of the present invention are formulated at pH values which allow for an unexpected greater stability of the color change additive, improved shelf stability of the formulation, longer color change times after application, lower volatile content and odor, and use with existing packaging.

The present disclosure is further directed to a method of applying a paint with these-properties. The paint of the present invention comprises a vehicle, acting as the continuous phase, and a pigment, acting as a discontinuous phase. The vehicle comprises a polymer and/or resin binder. In most cases the vehicle comprises a diluent such as water (in the case of emulsions). The pigment may include additives, primary pigment and/or extenders.

The polymer and/or resin binder are used as film formers or binders. Film formers or binders can either be low or high molecular weight polymers. The low molecular weight film formers or binders generally will not form solid films without further chemical reaction. Examples of low molecular weight film formers or binders include but are not limited to oleoresinous binders, alkyds, polyurethanes, urethane oils, amino resins, phenolic resins, epoxide resins, unsaturated polyesters, chlorinated rubber or combinations thereof. Examples of high molecular weight film formers or binders include but are not limited to nitrocellulose, solution vinyls, solution acrylics, non-aqueous dispersion polymers, polyvinyl acetate latex, acrylic latex, styrene/butadiene latex, vinyl latex, vinyl acrylic latex and the like and combinations thereof. Preferably, the film former or binder is a vinyl acrylic latex. Furthermore preferably, the vinyl acrylic latex is at least about 1% by weight of the total paint formulation, more preferably is at least about 3% by weight and most preferably is at least about 6% by weight of the total paint formulation.

The diluent, preferably, contains some or all water. The diluent is either an emulsion of a solvent and water, or a 100% water emulsion. Examples of solvents include but are not limited to methyl ethyl ketone, methyl isobutyl ketone, ethyl acetate, n-isobutyl acetates, perchlorethylene, trichlorethylene, isopropanol, acetone, methanol, glycol ethers, and the like and combinations thereof. More preferably, the diluent is water, which is used to emulsify the polymer and/or resin binder.

The amount of primary and extender pigment used in the paint of the present invention is determined by the pigments intensity and tinctorial strength, the required opacity, the required gloss, and/or the resistance and durability desired. Pigments used in the present invention can be inorganic, organic or combinations thereof. Examples of primary pigments include but are not limited to titanium dioxide, lead, zinc oxide, zinc sulphide, lithopone, antimony oxide, carbon black, graphite, black iron oxide, micaceous iron oxide, iron oxide, metal complexes, benzimidazolone, azo condensation, lead chromate, cadmium yellow, yellow oxides, mixed phase metal oxides, bismuth vanadate, arylamide, diarylide, benzimidazolone, disazo condensation, organic metal complexes, isoindolinone, isoindoline, quinophthalone, anthrapyrimidine, flavanthrone, pyrazolone orange, perinone orange, lead molybdate, cadmium red, red iron oxide, β-naphthol, BON arylamides, benzimidazolone, quinacridone, perylene, anthraquinone, dibromanthrone, pyranthrone, diketopyrrolo-pyrrole, prussian blue, ultramarine, cobalt blue, copper and copper free phthalocyanine, indanthrone, chrome green, chromium oxide, hydrated chromium oxide, halogenated copper phthalocyanine, metal flake, pearlescent pigments and the like and combinations thereof.

Extender pigments are used to extend the more expensive white and colored pigments to reduce the cost and impart certain performance characteristics to the paint. The use of extender pigments may affect the flow properties, the stability to sedimentation and the film strength. Most extenders are white in color and have a refractive index close to that of commonly used binders. Therefore, unlike titanium dioxide they give relatively little opacifying effect. Examples of extenders include but are not limited to calcium carbonate, aluminum silicate, magnesium silicate, barium sulphate, silica, and the like and combinations thereof.

Suitably, the paint further comprises a humectant. Examples of humectants include but are not limited to propylene glycol, ethylene glycol, polyethylene glycol, glycerol, sucrose and combinations thereof. While the humectant is not necessary for the present invention, the humectant has the unexpected ability to lengthen the time required for the paint to change colors upon drying.

Additives to paints are generally added at low levels but nevertheless have a marked effect on the properties of the paint. Examples of types of additives that are added to the paint of the present invention include but are not limited to anti-corrosive pigment enhancers, emulsifiers, surfactants, dispersants, curing agents, coalescents, wetting agents, biocides, thickeners, rheology modifiers, plasticizers, waxes, anti-oxidants, antifoaming agents, antisettling agents, antiskinning agents, corrosion inhibitors, dehydrators, antigassing agents, dispersion aids, driers, antistatic additives, flash corrosion inhibitors, floating and flooding additives, in-can and in-film preservatives, insecticidal additives, optical whiteners, reodorants, ultraviolet absorbers, and the like and combinations thereof.

The color change additive referred to in one or more embodiments of the present invention is directed more particularly to the addition of a pH sensitive color change additive to a paint. Suitably, the pH sensitive color change additive changes from a distinct color to nearly clear as the paint with the color change additive dries. By nearly clear, it is meant that the color is very light and can be compensated for by the addition of additional colorants or pigment to effectively suppresses the color to the average consumer. Preferably the color change additive begins to undergo a color change to clear or near clear at a pH less about than 10, more preferably at a pH less than about 9, and most preferably at a pH less than about 8.1 Examples of pH sensitive color change additives include but are not limited to 5′,5″-dibromo-ocresolsulfone-phthalein (bromocresol purple), 3′,3″-dichlorophenolsulfonephthalein (chlorophenol red), p-nitrophenol, alizarin, 2-(2,4-dinitrophenylazo)-1-naphthol-3,6-disulfonic acid, 3′,3″-dibromothymolsulfonephthalein (bromothymol blue), 6,8-dinitro-2,4-(1H) quinazolinedione, brilliant yellow, phenolsulfonephthalein (phenol red) or 4, 4′-(3H-2, 1-Benzoxathiol-3-ylidene) diphenol S, S-dioxide which is C₁₉H₁₄O₅S: 354.38 and has a CAS Registry Number of:143-74-8, and the like inlcuding salts thereof such as alkali metal and/or alkaline earth metal salts and any and all combinations thereof. The phenolsulfonphthalein additive above a pH of about 8.4, is a bright red, below a pH of about 6.8, it is yellow, with the color additive having varying shades of orange therebetween. Other examples of the color changes for a few of the usable color additives which may be used in this invention include: cresol red which has a pH range of 7.2-8.8 and would change from red to yellow, bromthymol blue which has a pH range of 6.2-7.6 and would change from blue to yellow, m-cresol purple which has a pH range of 7.6-9.2 and would change from purple to yellow, and thymol blue which has a pH range of 8.0-9.6 and would change from blue to yellow. For instance combinations of phenol red with phenolphthalein can be used as well as combinations of either or both of these with the other color changing additives. Most preferably, the pH sensitive color change additive is phenol red.

The intrinsic pH of a paint is the pH of the wet paint absent volatile acid or base. In one or more embodiments, the present invention further includes the addition of a base to increase the pH of the paint, or acid to reduce the pH of the paint. Preferably, this allows the color change additive which is nearly clear (or is a color which can be compensated for by the addition of other colorants or pigments) at the intrinsic pH of the paint to be of a color which is visible upon application by the person applying the coating, i.e., the painter, at these higher or lower pH's. Increasing the pH is the preferred route. With respect to adding a base, adding various bases, i.e., amines, at certain levels (and above) to paints containing particular base resins, i.e., vinyl acrylics, reduces the shelf life of the paints due to degradation of the base resin at higher pH's. This forces reformulation of the paint with more expensive resins, i.e., acrylics, to avoid an unacceptable reduction in shelf life, or a reduction in the original pH of the paint as supplied in the packaging container. Acids and bases which can be used to increase or decrease the pH of the paint formulation include ones known to those skilled in the art. For purposes of this invention these are known as pH modifiers. Examples of bases used as pH modifiers include but are not limited to amines including ammonia, NaOH, KOH, K₂CO₃, Na₂CO₃, Ca₂CO₃, other bases and salts of those bases, and the like and combinations thereof. For instance alkanolamines can be used such as any amino methyl propanol, diisopropanolamines and the like and mixtures thereor. Certain bases and base salts allow the paint to dry nearly clear, but will cause the paint to discolor upon re-wetting of the paint, such as through the consumer washing the surface. Preferably, only those acids or bases that are volatile or do not allow for an increase in alkalinity or acidity upon re-wetting are added. More preferably, somewhat volatile bases are added. Most preferably, amines are added. Furthermore, to lengthen the time for separation of these volatile pH modifiers from the coated paint, preferably higher boiling point volatile pH modifiers such as those with boiling points around 100° F. or greater are used. Preferably, the paint formulation comprises from about 0.0001 to about 3.0% by weight of a pH modifier, more preferably from about 0.0001 to about 2.0% by weight of a pH modifier, and most preferably from about 0.0001 to about 1.5% by weight of a pH modifier.

Due to the above, and that paints generally undergo a reduction or increase in pH towards neutral upon-drying. Preferably the paint as delivered and sold to the consumer in the packaging container has a pH of less than about 11, more preferably less than about 10.5, even more preferably less than about 10, still even more preferably less than about 9.5, still even more preferably less than about 9.0 and most preferably less than 8.5.

Suitably, the paints of the present invention have a viscosity allowing for ease of application. The viscosity is measured using a Brookfield RVT viscometer using a 5, 6 or 7 spindle at greater than 10 rpm. Preferably, the viscosity is less than about 100,000 centipoise, more preferably less than about 80,000 centipoise, even more preferably less than about 65,000 centipoise, and most preferably less than about 50,000 centipoise.

The paint formulations of the various embodiments of the present invention comprising a pH sensitive color change additive are mixed by conventional means using apparatus known to those skilled in the art. The paint formulation can be applied to a surface by various means including but not limited to brushing, rolling, spraying and the like. Generally a coating of the paint formulation is applied to a surface and forms a wet film. Examples of surfaces to which the paint formulation can be applied include but are not limited to wood, plastic, metal, cement, ceramic, paper, asphalt, plaster, plasterboard, previously primed or coated surfaces, and the like. Preferred substrates are architectural substrates such as walls, trim, clapboard, siding, window frames, ceilings, gypsum board, and the like. Due to the viscosity, the paint formulation coating is generally applied at less than 10 mil in thickness. Preferably, the paint formulation coating is applied at less than 6 mil in thickness.

After application to the surface the coating is allowed to air dry. During the process of air drying the coating, the color of the coating of paint formulation changes perceptibly over time. Preferably, the paint formulation changes perceptively over from about 5 minutes to about 24 hours after application on a surface. More preferably, the paint formulation changes perceptively over from about 8 minutes to about 8 hours after application on a surface. Even more preferably, the paint formulation changes perceptively over from about 12 minutes to about 4 hours after application on a surface. Even more preferably, the paint formulation changes perceptively over from about 16 minutes to about 2 hours after application on a surface. Even more preferably, the paint formulation changes perceptively over from about 25 minutes to about 2 hours after application on a surface. Even more preferably, the paint formulation changes perceptively over from about 35 minutes to about 2 hours after application on a surface. Most preferably, the paint formulation changes perceptively over from about 45 minutes to about 2 hours after application on a surface. It should be understood that the actual drying time for a film layer of the paint containing the color changing additive in accordance with the present invention can vary to a degree around the above recited times given the type of surface to which the paint is deposited on or applied. Actual drying time depends upon many factors, such as room or ambient temperature and layer thickness. The foregoing detailed description is given for clearness of understanding only, and no unnecessary limitations should be understood therefrom. Hence, numerous modifications and changes can be made by those skilled in the art without departing from the spirit and scope of the invention. The following examples will serve to further typify the nature of the invention, but should not be construed as a limitation on the scope thereof, which is defined solely by the appended claims.

The Figure is a color photograph of an elevational view away from the painted topcoat over a substrate showing multiple colors visible during use. The Figure shows three adjacent sections of the multicolored painted top coated design, where reference 1 of the Figure is for the most recently painted surface and reference 2 is of the painted topcoat surface not as recently painted as that for reference a and reference 3 is the earliest painted surface. The painted topcoat for references 1-3 are all the same coat ranging in color from pink for the latest painted surface to white for the earliest painted surface. So that the multicolored painted topcoat design is partially white.

### EXAMPLES

### Example 1

The paint formulation of this example was prepared by adding the following components to a 1-gallon stainless steel mixing vessel. In the grind stage, the following ingredients in Table I were added to the vessel in the same order as listed with the paint formulation-being agitated with an air motor with a 3″ high lift blade.

TABLE I

| Component | Weight (grams) |
|---|---|
| (i) Water (tap) | 860.0 |
| (ii) | |
| (iii) Cellulosic Thickener | 2.0 |
| Natrosol Plus 330 (Hercules, Inc of Wilmington, DE) | |
| Preservative | 6.0 |
| Dowicil 75 (Dow Chemical of Midland, MI) | |
| Aqueous anionic dispersant | 19.2 |
| Tamol 731 A (Rohm & Haas of Philadelphia, PA) | |
| Non-silica defoamer | 4.0 |
| Drewplus Y-381 (Drew Industrial of Boonton, NJ) | |
| Disodium phosphate, anhydrous | 6.0 |
| (Albright & Wilson Americas of Richmond, VA) | |
| Nonionic nonylphenol surfactant | 12.0 |
| Igepal CTA-639-W (Rhodia of Cranbury, NJ) | |
| Nonionic octylphenol surfactant | 6.0 |
| Triton X405 (Dow Chemical of Midland, MI) | |
| 2-amino-2-methyl-1-propanol solution | 19.6 |
| AMP-95 (Angus Chemical of Buffalo Grove, IL) | |

The following ingredients in Table II were then added to the paint formulation with a Hockmeyer Model H-2 discperser with a 3″ cowles-type blade operating at 3000 rpm. Following the addition of these ingredients, the paint formulation was agitated for another 10 minutes.

TABLE II

| | Weight |
|---|---|
| Component | (grams) |
| (iv) Calcined kaolin clay | 900.0 |
| Satintone W (Engelhard Corp of Iselin, NJ) | |
| (v) | |
| (vi) Magnesium silicate | 300.0 |
| Talcron MP 44-26 (Barrets Minerals of Bethlehem, PA) | |
| Rutile titanium dioxide | 244.0 |
| Tiona 596 (Millenium Inorganic Chemicals of Baltimore, MD) | |
| Phenolsulfonephthalein | 0.08 |
| Phenol Red (Amresco, Inc of Solon, OH) | |
| Sodium aluminosilicate | 40.0 |
| Zeolex 80 (J.M. Huber Corp of Havre DeGrace, MD) | |
| Silica, diatomaceous earth, uncalcined | 40.0 |
| Diafil 525 (Celite of Lompoc, CA) | |

The following components in Table III were then added to the paint formulation and agitated for another 5 minutes. At this point the temperature of the formulation was measured as being at 102° F.

TABLE III

| Component | Weight (grams) |
|---|---|
| (vii) Thickener, colloidal silicate | 20.0 |
| Attagel 50 (Engelhard Corp of Iselin, NJ) | |
| Water (tap) | 212 |

The agitation was reduced to 1000 rpm and 720.9 grams of tap water was added to the paint formulation. Then the following components in Table IV were added in order using an air motor with a 3″ high lift blade.

TABLE IV

| | Weight |
|---|---|
| Component | (grams) |
| 2,2,4-trimethyl-1,3-pentanediol monoisobutyrate | 24.0 |
| Texanol, ester alcohol (Eastman Chemical of Kingsport, TN) | |
| Non-silica defoamer | 8.0 |
| Drewplus Y-381 (Drew Industrial of Boonton, NJ) | |
| Vinyl acrylic latex | 389.2 |
| (Dow Chemical of Cary, NC) | |
| Ammonium hydroxide solution 19% | 12.0 |
| (Van Waters & Rogers, Inc. of Twinsburg, OH) | |
| Acrylic polymer thickener | 76 |
| Acrysol DR-73 (Rohm & Haas of Philadelphia, PA) | |
| Water (tap) | 448.0 |
| Non-silica defoamer | 8.0 |
| Drewplus Y-381 (Drew Industrial of Boonton, NJ) | |

The paint formulation in this example was aged for 1 day on a shelf in a standard metal container. The pH of the aged paint formulation was 9.4. The paint formulation was tested to determine the time required for a perceptible color change. To measure the time required for the paint formulation to change color, the paint formulation was drawn down using a 6 mil Bird blade on the unsealed back of a 3B Leneta Co. opacity chart. The applicants have found that this method is found to approximately correspond to the color time change of roller application of paint formulations over bare drywall using a ⅜″ nap roller. The color change time for the aged paint formulation was 18 minutes. In addition, the paint formulation was tested for both pH and color change time as shown in Table V after aging over a four week time frame at both room temperature and 140° F. During the aging tests, the viscosity of the paint formulation remained relatively unchanged.

TABLE V

| | pH | Color Change Time (min) |
|---|---|---|
| Aging (at RT) | | |
| One day | 9.4 | 15-18 |
| 2 weeks | 9.0 | 19-23 |
| 4 weeks | 9.0 | 17-22 |
| Aging (at 140° F.) | | |
| 1 week | 9.4 | Not evaluated |
| 2 week | 8.4 | 15-18 |
| 4 week | 8.3 | 16-19 |

The results of these tests show that this paint formulation is stable over a period of time and even under accelerated aging conditions. Additionally, it was found under these conditions that the vinyl acrylic latex film former did not degrade.

### Example 2

The paint formulation of this example was prepared by adding the following components to a 1 liter mixing vessel. In the grind stage, the following ingredients in Table VI were added to the vessel in the same order as listed with the paint formulation being mixed with a 1.5″ diameter high lift blade.

TABLE VI

| Component | Weight (grams) |
|---|---|
| Water (tap) | 215.0 |
| Cellulosic Thickener | 0.5 |
| Natrosol Plus 330 (Hercules, Inc of Wilmington, DE) | |
| Preservative/Biocide | 1.5 |
| Dowicil 75 (Dow Chemical of Midland, MI) | |
| Aqueous anionic dispersant | 4.8 |
| Tamol 731 A (Rohm & Haas of Philadelphia, PA) | |
| Non-silica defoamer | 1.0 |
| Drewplus Y-381 (Drew Industrial of Boonton, NJ) | |
| Disodium phosphate, anhydrous | 1.5 |
| (Albright & Wilson Americas of Richmond, VA) | |
| Nonionic nonylphenol surfactant | 3.0 |
| Igepal CTA-639-W (Rhodia of Cranbury, NJ) | |
| Nonionic octylphenol surfactant | 1.5 |
| Triton X405 (Dow Chemical of Midland, MI) | |
| 2-amino-2-methyl-1-propanol solution | 0.5 |
| AMP-95 (Angus Chemical of Buffalo Grove, IL) | |

The following ingredients in Table VII were then added to the paint formulation with a 2″ diameter cowles type blade at 3600 rpm. Following the addition of these ingredients, the paint formulation was agitated for another 10 minutes.

TABLE VII

| | Weight |
|---|---|
| Component | (grams) |
| Calcined kaolin clay | 225.0 |
| Satintone W (Engelhard Corp of Iselin, NJ) | |
| Magnesium silicate | 75.0 |
| Talcron MP 44-26 (Barrets Minerals of Bethlehem, PA) | |
| Rutile titanium dioxide | 61.0 |
| Tiona 596 (Millenium Inorganic Chemicals | |
| of Baltimore, MD) | |
| Phenolsulfonephthalein | 0.0175 |
| Phenol Red (Amresco, Inc of Solon, OH) | |
| Sodium aluminosilicate | 10.0 |
| Zeolex 80 (J.M. Huber Corp of Havre DeGrace, MD) | |
| Silica, diatomaceous earth, uncalcined | 10.0 |
| Diafil 525 (Celite of Lompoc, CA) | |

An 5.0 grams of anti-settling agent (under the tradename Attagel 50 from Engelhard Corp of Iselin, N.J.) was then added to the paint formulation. The paint formulation was then agitated for another 5 minutes. The following components in Table VIII were added in order using an air motor with a 1.5″ high lift blade.

TABLE VIII

| | Weight |
|---|---|
| Component | (grams) |
| Water (tap) | 180.2 |
| 2,2,4-trimethyl-1,3-pentanediol monoisobutyrate | 6.0 |
| Texanol, ester alcohol (Eastman Chemical of Kingsport, TN) | |
| Non-silica defoamer | 2.0 |
| Drewplus Y-381 (Drew Industrial of Boonton, NJ) | |
| Vinyl acrylic latex | 97.3 |
| (Dow Chemical of Cary, NC) | |
| Ammonium hydroxide solution 19% | 3.0 |
| (Van Waters & Rogers, Inc. of Twinsburg, OH) | |
| Acrylic polymer thickener | 19.0 |
| Acrysol DR-73 (Rohm & Haas of Philadelphia, PA) | |
| Water (tap) | 112.0 |
| Non-silica defoamer | 2.0 |
| Drewplus Y-381 (Drew Industrial of Boonton, NJ) | |
| 2-amino-2-methyl-1-propanol | 4.4 |
| AMP-95 (Angus Chemical of Buffalo Grove, IL | |
| Colorant | 0.1 |

The paint formulation in this example was tested to determine the time required for a perceptible color change. To measure the time required for the paint formulation to change color, the paint formulation was applied to primed drywall using a ⅜″ nap roller. The color change time for the aged paint formulation was 18 minutes.

### Example 3

The paint formulation of this example is prepared by adding the following components to a 1-gallon stainless steel mixing vessel. In the grind stage, the following ingredients in Table IX are added to the vessel in the same order as listed with the paint formulation being agitated with an air motor with a 1.5″ high lift blade.

TABLE IX

| | Weight |
|---|---|
| Component | (grams) |
| Water (tap) | 185.0 |
| Cellulosic Thickener | 0.5 |
| Natrosol Plus 330 (Hercules, Inc of Wilmington, DE) | |
| Bentonite | 6.5 |
| Bentolite WH Rheological additive | |
| (Southern Clay Products, Inc.) | |
| Preservative | 1.5 |
| Dowicil 75 (Dow Chemical of Midland, MI) | |
| Silica defoamer | 4.0 |
| Drewplus L475 (Drew Industrial of Boonton, NJ) | |
| Polymeric dispersant solution | 6.0 |
| Tamol 165A (Rohm&Haas of Philadelphia, PA) | |
| Potassium tripolyphosphate | 1.5 |
| (Albright&Wilson Americas of Richmond, VA) | |
| Disodium phosphate, anhydrous | 1.5 |
| (Albright&Wilson Americas of Richmond, VA) | |
| Nonionic nonylphenol surfactant | 3.0 |
| Igelpal CTA-639-W (Rhodia of Cranbury, NJ) | |

The following ingredients in Table X are then added to the paint formulation with a Hockmeyer Model H-2 discperser with a 2″ cowles-type blade operating at 3600 rpm. Following the addition of these ingredients, the paint formulation is agitated for another 10 minutes.

TABLE X

| | Weight |
|---|---|
| Component | (grams) |
| Calcined kaolin | 145.0 |
| (Engelhard Corp. of Iselin, NJ) | |
| Magnesium silicate (talc) | 85.0 |
| Talcron MP 44-26 (Barrets Minerals, Inc of Bethlehem, PA) | |
| Reclaimed pigment | 10.0 |
| Phenolsulfonephthalein (Phenol Red) | 0.02 |
| (Amresco of Solon, OH) | |

The agitation was reduced to 1000 rpm and 40.0 grams of tap water is then added to the paint formulation. Then the following components in Table XI is then added in order using an air motor with a 1.5″ high lift blade.

TABLE XI

| | Weight |
|---|---|
| Component | (grams) |
| Titanium dioxide slurry | 24.0 |
| Tiona RCS-3X (Millenium Inorganic Chem of Baltimore, MD) | |
| Water, tap | 199.2 |
| Texanol, (2,2,4-trimethyl-1,3-pentanediol monoisobutyrate | 5.5 |
| (Eastman Chemical of Kingsport, TN) | |
| Silica defoamer | 2.0 |
| Drewplus L475 (Drew Industrial of Boonton, NJ) | |
| Vinyl acrylic latex | 87.6 |
| (Dow Chemical of Cary, NC) | |
| 2-amino-2-methyl-1-propanol solution | 6.0 |
| AMP-95 (Angus Chemical of Buffalo Grove, IL) | |
| Ammonium hydroxide solution 19% | 3.0 |
| (Van Waters & Rogers, Inc. of Twinsburg, OH) | |
| Acrylic polymer thickener | 15.0 |
| Acrysol DR-73 (Rohm & Haas of Philadelphia, PA) | |
| Water (tap) | 151.0 |
| Silica defoamer | 2.0 |
| Drewplus L475 (Drew Industrial of Boonton, NJ) | |

This paint formulation is expected to age in a similar manner to those described in Examples 1 and 2. Further the paint formulation is expected to have a pH and color change characteristics similar to those in Examples 1 and 2.

### Example 4

The paint formulation of this example is prepared by adding the following components to a 1-liter stainless steel mixing vessel. In the grind stage, formulation is prepared first with the ingredients in Table XII being added to the vessel in the same order as listed with the paint formulation being agitated with an air motor with a 1.5″ high lift blade.

TABLE XII

| Component | Weight (grams) |
|---|---|
| Water (tap) | 190.0 |
| Cellulosic thickener | 0.5 |
| Natrosol Plus 330 (Hercules Inc. of Wilmington, DE) | |
| Preservative | 1.5 |
| Dowicil 75 (Dow Chemical of Midland, MI) | |
| Aqueous anionic dispersant | 4.8 |
| Tamol 731 A (Rohm & Haas of Philadelphia, PA) | |
| Non-silica defoamer | 1.0 |
| Drewplus Y-381 (Drew Industrial of Boonton, NJ) | |
| Disodium phosphate, anhydrous | 1.5 |
| (Albright & Wilson Americas of Richmond, VA) | |
| Nonionic nonylphenol surfactant | 3.0 |
| Igepal CTA-639-W (Rhodia of Cranbury, NJ) | |
| 2-amino-2-methyl-1-propanol | 0.5 |
| AMP-95 (Angus Chemical of Buffalo Grove, IL) | |

The following ingredients in Table XIII are then added to the paint formulation with a Hockmeyer Model H-2 discperser with a 2″ cowles-type blade operating at 3600 rpm. Following the addition of these ingredients, the paint formulation is agitated for another 10 minutes.

TABLE XIII

| | Weight |
|---|---|
| Component | (grams) |
| Calcined kaolin clay | 225.0 |
| Satintone W (Englehard Corp of Iselin, NJ) | |
| Magnesium silicate (talc) | 75 |
| Talcron MP 44-26 (Barrets Minerals, Inc of Bethlehem, PA) | |
| Rutile titanium dioxide | 61.0 |
| Tiona 596 (Millenium Inorganic Chemicals of Baltimore, MD) | |
| Sodium aluminosilicate | 10.0 |
| Zeolex 80 (J. M. Huber Corp of Havre DeGrace, MD) | |
| Uncalcined silica | 10.0 |
| Diafil 525 (Celite of Lompoc, CA) | |

5.0 grams of colloidal silicate thickener (Attagel 50 made by Engelhard Corp. of Iselin, N.J.) is then added and the formulation is agitated for an additional 5 minutes. The agitation was reduced to 1000 rpm and 53 grams of tap water is then added to the paint formulation. The following components in Table XI are then added in order using an air motor with a 1.5″ high lift blade.

TABLE XIV

| | Weight |
|---|---|
| Component | (grams) |
| Water, tap | 190.8 |
| Titanium dioxide slurry | 24.0 |
| Tiona RCS-3X (Millenium Inorganic Chem of Baltimore, MD) | |
| Water, tap | 199.2 |
| Cellulosic thickener | 4.0 |
| Natrosol Plus 330 (Hercules, Inc. of Wilmington, DE) | |
| Ammonium hydroxide solution 19% | 1.5 |
| (Van Waters & Rogers, Inc. of Twinsburg, OH) | |
| Texanol, (2,2,4-trimethyl-1,3-pentanediol monoisobutyrate | 6.0 |
| (Eastman Chemical of Kingsport, TN) | |
| Non-silica defoamer | 2.0 |
| Drewplus Y-381 (Drew Industrial of Boonton, NJ) | |
| Vinyl acrylic latex | 97.3 |
| (Dow Chemical of Cary, NC) | |
| Water, tap | 58.0 |
| Polyurethane thickener | 7.5 |
| Acrysol RM-825 (Rohm & Haas of Philadelphia, PA) | |
| Non-silica defoamer | 2.0 |
| Drewplus Y-381 (Drew Industrial of Boonton, NJ) | |
| Water, tap | 20.0 |
| 2-amino-2-methyl-1-propanol solution | 8.0 |
| AMP-95 (Angus Chemical of Buffalo Grove, IL) | |
| Phenolsulfonephthalein/phenol red | 0.02 |
| (Amresco, Inc. of Solon, OH) | |

This paint formulation is expected to age in a similar manner to those described in Examples 1 and 2. Further the paint formulation is expected to have a pH and color change characteristics similar to those in Examples 1 and 2.

### Example 5

The paint formulation of this example is prepared by adding the following components to a 1-liter stainless steel mixing vessel. In the grind stage, the formulation is prepared first with the ingredients in Table XV being added to the vessel in the same order as listed with the paint formulation being agitated with an air motor with a 1.5″ high lift blade.

TABLE XV

| Component | Weight (grams) |
|---|---|
| Water (tap) | 117.1 |
| Cellulosic thickener | 0.25 |
| Natrosol Plus 330 (Hercules Inc. of Wilmington, DE) | |
| Anionic aqueous dispersant | 4.0 |
| Hydropalat 44 (Cognis) | |
| Non-silica defoamer | 1.0 |
| Drewplus Y-381 (Drew Industrial of Boonton, NJ) | |
| Phosphate ester dispersant/wetting agent | 4.9 |
| Strodex PK-0VOC (Dexter Chemical) | |
| Preservative | 1.5 |
| Dowicil 75 (Dow Chemical of Midland, MI) | |
| Alkyl phenyl alkoxylate, surfactant | 4.0 |
| Ukanil 2283 (Uniqema) | |
| 2-amino-2-methyl-1-propanol | 1.0 |
| AMP-95 (Angus Chemical of Buffalo Grove, IL) | |
| Disodium phosphate, anhydrous | 2.0 |
| (Albright & Wilson Americas of Richmond, VA) | |

The following ingredients in Table XVI are then added to the paint formulation with a Hockmeyer Model H-2 discperser with a 2″ cowles-type blade operating at 3600 rpm. Following the addition of these ingredients, the paint formulation is agitated for another 10 minutes.

TABLE XVI

| Component | Weight (grams) |
|---|---|
| Titanium dioxide | 245.0 |
| Tioxide R-TC90 (Tioxide America) | |
| Sodium potassium aluminosilicate, anhydrous | 90.0 |
| (Unimin Canada) | |
| Silica, diatomaceous earth | 13.0 |
| Diafil 575 (Celite of Lompoc, CA) | |

29.6 grams of tap water is then added and the formulation is agitated for an additional 5 minutes. The agitation was reduced to 1000 rpm then the following components in Table XVII are then added in order using an air motor with a 1.5″ high lift blade.

TABLE XVII

| | Weight |
|---|---|
| Component | (grams) |
| Water, tap | 56.9 |
| Ammonium hydroxide solution 19% | 0.35 |
| (Van Waters & Rogers, Inc. of Twinsburg, OH) | |
| Water, tap | 17.0 |
| Cellulosic thickener | 0.9 |
| Natrosol Plus 330 (Hercules, Inc. of Wilmington, DE) | |
| Diethylene glycol | 20.0 |
| (Dow Chemicals of Midland, MI) | |
| Texanol, 2,2,4-trimethyl-1,3-pentanediol monoisobutyrate | 20.0 |
| (Eastman Chemical of Kingsport, TN) | |
| Polyurethane emulsion, nonionic thickener | 5.0 |
| Acrysol RM-1020 (Philadelphia, PA) | |
| Polyurethane thickener | 13.0 |
| Acrysol RM-825 (Rohm & Haas of Philadelphia, PA) | |
| Nonionic octylphenol surfactant | 2.0 |
| Triton X405 (Dow Chemical of Midland, MI) | |
| Non-silica defoamer | 2.0 |
| Drewplus Y-381 (Drew Industrial of Boonton, NJ) | |
| Styrene acrylic latex | 80.0 |
| (Rohm & Haas of Philadelphia, PA) | |
| Vinyl acrylic emulsion | 300.0 |
| Rovace 661PS (Rohm & Haas of Philadelphia, PA) | |
| Non-silica defoamer | 6.0 |
| Drewplus Y-381 (Drew Industrial of Boonton, NJ) | |
| Styrene/acrylic emulsion | 75.0 |
| Ropaque OP62 LO (Rohm & Haas of Philadelphia, PA) | |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in a similar manner to those described in Examples 1 and 2. Further the paint formulation is expected to have a pH and color change characteristics similar to those in Examples 1 and 2.

### Example 6

The following exterior paint formulation of this example is prepared by adding the following components to a 1-liter stainless steel mixing vessel. In the grind stage, the formulation is prepared first with the ingredients in Table XVIII being added to the vessel in the same order as listed with the paint formulation being agitated with an air motor with a 1.5″ high lift blade for 20 minutes.

TABLE XVIII

| Component | Weight (grams) |
|---|---|
| Thickener/rheology modifier | 120.0 |
| Natrosol 250 MHR (Aqualon Company) | |
| Ethylene glycol | 25.0 |
| Propylene glycol | 35.0 |
| Dispersant | 6.8 |
| Tamol 1124 (Rohm & Haas of Philadelphia, PA) | |
| Surfactant/wetting agent | 1.0 |
| Triton CF-10 (Dow Chemical of Midland, MI) | |
| Defoamer | 2.0 |
| Colloid 643 (Colloids, Inc) | |
| Titanium dioxide | 225.0 |
| TiPure R-902 (E.I. DuPont de Nemours and | |
| Company of Wilmington, DE) | |
| Alkali aluminum silicate, extender | 160.0 |
| Minex 4 (Industmin, Inc) | |
| Calcined clay, extender | 50.0 |
| Icecap K (Unimin Specialty Minerals, Inc) | |

The following ingredients in Table XIX are then added to the paint formulation with a Hockmeyer Model H-2 discperser with a 2″ cowles-type blade operating at 3600 rpm. Following the addition of these ingredients, the paint formulation is agitated for another 10 minutes.

TABLE XIX

| | Weight |
|---|---|
| Component | (grams) |
| Acrylic | 350.0 |
| Rhoplex Multilobe 200 (Rohm&Haas Company, | |
| Philadelphia, PA) | |
| Texanol, 2,2,4-trimethyl-1,3-pentanediol monoisobutyrate | 9.3 |
| (Eastman Chemical of Kingsport, TN) | |
| Defoamer | 2.0 |
| Colloid 643 (Colloids, Inc.) | |
| Ammonia 28% | 2.2 |
| (viii) Thickener/rheology modifier | 76.0 |
| (ix) Natrosol 250 MHR (Aqualon Company) | |
| Water, tap | 92.8 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in a similar manner to those described in Examples 1 and 2. Further the paint formulation is expected to have a pH and color change characteristics similar to those in Examples 1 and 2.

### Example 7

The following exterior paint formulation of this example is prepared by adding the following components to a 1-liter stainless steel mixing vessel. In the grind stage, the formulation is prepared first with the ingredients in Table XX being added to the vessel in the same order as listed with the paint formulation being agitated with an air motor with a 1.5″ high lift blade for 20 minutes.

TABLE XX

| Component | Weight (grams) |
|---|---|
| Thickener/rheology modifier | 120.0 |
| Natrosol 250 MHR (Aqualon Company) | |
| Ethylene glycol | 25.0 |
| Propylene glycol | 35.0 |
| Dispersant | 4.6 |
| Tamol 1124 (Rohm & Haas of Philadelphia, PA) | |
| Surfactant/wetting agent | 1.0 |
| Triton CF-10 (Dow Chemical of Midland, MI) | |
| Defoamer | 2.0 |
| Colloid 643 (Colloids, Inc) | |
| Titanium dioxide | 150.0 |
| TiPure R-902 (E.I. DuPont de Nemours and Company | |
| of Wilmington, DE) | |
| Alkali aluminum silicate, extender | 50.0 |
| Minex 4 (Industmin, Inc) | |
| Calcined clay, extender | 15.0 |
| Icecap K (Unimin Specialty Minerals, Inc) | |
| Diatomaceous silica, extender | 45.0 |
| Celite 281 (Johns Manville) | |

The following ingredients in Table XXI are then added to the paint formulation with a Hockmeyer Model H-2 discperser with a 2″ cowles-type blade operating at 3600 rpm. Following the addition of these ingredients, the paint formulation is agitated for another 10 minutes.

TABLE XXI

| | Weight |
|---|---|
| Component | (grams) |
| Polymeric hiding agent | 120.0 |
| Ropaque OP-62 LO (Rohm & Haas of Philadelphia, PA) | |
| Acrylic | 336.8 |
| Rhoplex Multilobe 200 (Rohm&Haas Company, | |
| Philadelphia, PA) | |
| Texanol, 2,2,4-trimethyl-1,3-pentanediol monoisobutyrate | 11.2 |
| (Eastman Chemical of Kingsport, TN) | |
| Defoamer | 2.0 |
| Colloid 643 (Colloids, Inc.) | |
| Ammonia 28% | 0.6 |
| Thickener/rheology modifier | 49.0 |
| Natrosol 250 MHR (Aqualon Company) | |
| Water, tap | 72.3 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 8

The following exterior paint formulation of this example is prepared by adding the following components to a 1-liter stainless steel mixing vessel. In the grind stage, the formulation is prepared first with the ingredients in Table XXII being added to the vessel in the same order as listed with the paint formulation being agitated with an air motor with a 1.5″ high lift blade for 20 minutes.

TABLE XXII

| Component | Weight (grams) |
|---|---|
| Thickener/rheology modifier | 100.0 |
| Natrosol 250 MHR (Aqualon Company) | |
| Ethylene glycol | 20.0 |
| Dispersant | 5.3 |
| Tamol 1124 (Rohm & Haas of Philadelphia, PA) | |
| Surfactant/wetting agent | 1.0 |
| Triton CF-10 (Dow Chemical of Midland, MI) | |
| Defoamer | 2.0 |
| Colloid 643 (Colloids, Inc) | |
| Titanium dioxide | 175.0 |
| TiPure R-902 (E.I. DuPont de Nemours and Company of | |
| Wilmington, DE) | |
| Alkali aluminum silicate, extender | 280.0 |
| Minex 4 (Industmin, Inc) | |

The following ingredients in Table XXIII are then added to the paint formulation with a Hockmeyer Model H-2 discperser with a 2″ cowles-type blade operating at 3600 rpm. Following the addition of these ingredients, the paint formulation is agitated for another 10-minutes.

TABLE XXIII

| | Weight |
|---|---|
| Component | (grams) |
| Acrylic | 295.0 |
| Rhoplex Multilobe 200 (Rohm&Haas Company, | |
| Philadelphia, PA) | |
| Texanol, 2,2,4-trimethyl-1,3-pentanediol monoisobutyrate | 7.9 |
| (Eastman Chemical of Kingsport, TN) | |
| Defoamer | 2.0 |
| Colloid 643 (Colloids, Inc.) | |
| Ammonia 28% | 1.6 |
| (x) Thickener/rheology modifier | 140.0 |
| (xi) Natrosol 250 MHR (Aqualon Company) | |
| Water, tap | 127.1 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 9

The following exterior paint formulation of this example is prepared by adding the following components to a 1-liter stainless steel mixing vessel. In the grind stage, the formulation is prepared first with the ingredients in Table XXII being added to the vessel in the same order as listed with the paint formulation being agitated with an air motor with a 1.5″ high lift blade for 20 minutes.

TABLE XXIV

| Component | Weight (grams) |
|---|---|
| (xii) Thickener/rheology modifier | 123.0 |
| (xiii) Natrosol 250 MHR (Aqualon Company) | |
| (xiv) Ethylene glycol | 25.0 |
| Propylene glycol | 34.0 |
| Dispersant | 9.5 |
| Tamol 850 (Rohm & Haas of Philadelphia, PA) | |
| Potassium tripolyphosphate | 1.5 |
| Surfactant/wetting agent | 2.5 |
| Triton CF-10 (Dow Chemical of Midland, MI) | |
| Defoamer | 1.0 |
| Colloid 643 (Colloids, Inc) | |
| Titanium dioxide | 225.0 |
| TiPure R-902 (E.I. DuPont de Nemours and Company of | |
| Wilmington, DE) | |
| Zinc oxide, mildewstat | 25.0 |
| AZO 66LP (Asarco, Inc) | |
| Alkali aluminum silicate, extender | 150.0 |
| Minex 4 (Industmin, Inc) | |
| Calcined clay, extender | 50.0 |
| Icecap K (Unimin Specialty Minerals, Inc) | |
| Thickener/rheology modifier | 5.0 |
| Attagel (Engelhard Corp. of Iselin, NJ) | |

The following ingredients in Table XXV are then added to the paint formulation with a Hockmeyer Model H-2 discperser with a 2″ cowles-type blade operating at 3600 rpm. Following the addition of these ingredients, the paint formulation is agitated for another 10 minutes.

TABLE XXV

| | Weight |
|---|---|
| Component | (grams) |
| Acrylic | 345.0 |
| Rhoplex Multilobe 200 (Rohm&Haas Company, | |
| Philadelphia, PA) | |
| Texanol, 2,2,4-trimethyl-1,3-pentanediol monoisobutyrate | 9.2 |
| (Eastman Chemical of Kingsport, TN) | |
| Defoamer | 3.0 |
| Colloid 643 (Colloids, Inc.) | |
| Mildewcide | 2.0 |
| Skane M-8 (Rohm & Haas of Philadelphia, PA) | |
| Ammonia 28% | 0.2 |
| (xv) Thickener/rheology modifier | 94.0 |
| (xvi) Natrosol 250 MHR (Aqualon Company) | |
| Water, tap | 71.6 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 10

The following exterior paint formulation of this example is prepared by adding the following components to a 1-liter stainless steel mixing vessel. In the grind stage, the formulation is prepared first with the ingredients in Table XXVI being added to the vessel in the same order as listed with the paint formulation being agitated with an air motor with a 1.5″ high lift blade for 20 minutes.

TABLE XXVI

| Component | Weight (grams) |
|---|---|
| (xvii) Water, tap | 40.0 |
| (xviii) Thickener/rheology modifier | 80.0 |
| (xix) Natrosol 250 MHR (Aqualon Company) | |
| (xx) Ethylene glycol | 25.0 |
| Propylene glycol | 35.0 |
| Dispersant | 6.0 |
| Tamol 1124 (Rohm & Haas of Philadelphia, PA) | |
| Defoamer | 2.0 |
| Drewplus L-464 (Drew Industrial of Boonton, NJ) | |
| Titanium dioxide | 200.0 |
| TiPure R-902 (E.I. DuPont de Nemours and Company of | |
| Wilmington, DE) | |
| Silica | 225.0 |
| Silverbond B (Unimin Specialty Minerals, Inc.) | |

The following ingredients in Table XXVII are then added to the paint formulation with a Hockmeyer Model H-2 discperser with a 2″ cowles-type blade operating at 3600 rpm. Following the addition of these ingredients, the paint formulation is agitated for another 10 minutes.

TABLE XXVII

| | Weight |
|---|---|
| Component | (grams) |
| Acrylic | 340.0 |
| Rhoplex Multilobe 200 (Rohm&Haas Company, | |
| Philadelphia, PA) | |
| Texanol, 2,2,4-trimethyl-1,3-pentanediol monoisobutyrate | 9.0 |
| (Eastman Chemical of Kingsport, TN) | |
| Defoamer | 2.0 |
| Drewplus L-464 (Drew Industrial of Boonton, NJ) | |
| Ammonia 28% | 1.5 |
| Thickener/rheology modifier | 105.0 |
| Natrosol 250 MHR (Aqualon Company) | |
| Water, tap | 77.6 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 11

The following exterior paint formulation of this example is prepared by adding the following components to a 1-liter stainless steel mixing vessel. In the grind stage, the formulation is prepared first with the ingredients in Table XXVIII being added to the vessel in the same order as listed with the paint formulation being agitated with an air motor with a 1.5″ high lift blade for 20 minutes.

TABLE XXVIII

| Component | Weight (grams) |
|---|---|
| Water, tap | 8.5 |
| Propylene glycol | 60.0 |
| Defoamer | 2.0 |
| Colloid 643 (Colloids, Inc.) | |
| Dispersant | 5.7 |
| Tamol 963 (Rohm & Haas of Philadelphia, PA) | |
| Titanium dioxide | 200.0 |
| TiPure R-902 (E.I. DuPont de Nemours and Company of | |
| Wilmington, DE) | |
| Silica, extender | 50.0 |
| Imsil A-10 (Unimin Specialty Minerals) | |

The following ingredients in Table XXIX are-then added to the paint formulation with a Hockmeyer Model H-2 discperser with a 2″ cowles-type blade operating at 3600 rpm. Following the addition of these ingredients, the paint formulation is agitated for another 10 minutes.

TABLE XXIX

| | Weight |
|---|---|
| Component | (grams) |
| Polymeric hiding agent | 90.0 |
| Ropaque OP-62 LO (Rohm & Haas of Philadelphia, PA) | |
| Acrylic | 375.0 |
| Rhoplex Multilobe 200 (Rohm&Haas Company, | |
| Philadelphia, PA) | |
| Texanol, 2,2,4-trimethyl-1,3-pentanediol monoisobutyrate | 11.7 |
| (Eastman Chemical of Kingsport, TN) | |
| Defoamer | 2.0 |
| Colloid 643 (Colloids, Inc.) | |
| Propylene glycol | 15.0 |
| Ammonia 28% | 2.7 |
| (xxi) Thickener/rheology modifier | 153.0 |
| (xxii) Natrosol 250 MHR (Aqualon Company) | |
| Water, tap | 66.6 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 12

The following exterior paint formulation of this example is prepared by adding the following components to a 1-liter stainless steel mixing vessel. In the grind stage, the formulation is prepared first with the ingredients in Table XXX being added to the vessel in the same order as listed with the paint formulation being agitated with an air motor with a 1.5″ high lift blade for 20 minutes.

TABLE XXX

| Component | Weight (grams) |
|---|---|
| (xxiii) Water, tap | 44.8 |
| Ethylene glycol | 25.0 |
| Propylene glycol | 35.0 |
| Dispersant | 2.0 |
| Tamol 1124 (Rohm & Haas of Philadelphia, PA) | |
| Surfactant/wetting agent | 1.0 |
| Triton CF-10 (Dow Chemical of Midland, MI) | |
| Defoamer | 2.0 |
| Colloid 643 (Colloids, Inc.) | |
| Titanium dioxide | 225.0 |
| TiPure R-902 (E.I. DuPont de Nemours and Company of | |
| Wilmington, DE) | |
| Alkali aluminum silicate, extender | 160.0 |
| Minex 4 (Indusmin, Inc.) | |
| Calcined clay, extender | 50.0 |
| Icecap K (Unimin Specialty Minerals, Inc.) | |

The following ingredients in Table XXXI are then added to the paint formulation with a Hockmeyer Model H-2 discperser with a 2″ cowles-type blade operating at 3600 rpm. Following the addition of these ingredients, the paint formulation is agitated for another 10 minutes.

TABLE XXXI

| | Weight |
|---|---|
| Component | (grams) |
| Acrylic | 350.0 |
| Rhoplex Multilobe 200 (Rohm&Haas Company, | |
| Philadelphia, PA) | |
| Texanol, 2,2,4-trimethyl-1,3-pentanediol monoisobutyrate | 9.3 |
| (Eastman Chemical of Kingsport, TN) | |
| Defoamer | 2.0 |
| Colloid 643 (Colloids, Inc.) | |
| 2-amino-2-methyl-1-propanol solution | 1.4 |
| AMP-95 (Angus Chemical of Buffalo Grove, IL) | |
| Thickener/rheology modifier | 14.0 |
| Acrysol RM-1020 (Rohm & Haas of Philadelphia, PA) | |
| (xxiv) Thickener/rheology modifier | 97.0 |
| (xxv) Natrosol 250 MHR (Aqualon Company) | |
| Water, tap | 139.2 |
| Phenolsulfonephthalein/phenol red/sodium salt | 0.02 |
| (Amresco, Inc. of Solon, OH) | |
| 2-amino-2-methyl-1-propanol solution | 5.0 |
| AMP-95 (Angus Chemical of Buffalo Grove, IL) | |

This paint formulation is expected to age in the can in a similar manner to those described in Examples 1 and 2. Further the paint formulation is expected to have a pH and color change characteristics similar to those in Examples 1 and 2.

### Example 13

### Paint Formulation with Humectant

The paint formulation of this example was prepared by adding the following components in Table XXXII to a 2.5 Liter stainless steel dispersion vessel. In the grind stage, the following ingredients in Table 1 were added to the vessel in the same order as listed with the paint formulation being agitated with a high speed disperser Dispermat MG-E7 from VMA Getzmann GMBH) fitted with a 100 mm cowles type blade operating at 1000 rpm.

TABLE XXXII

| Component | Weight (grams) |
|---|---|
| Tap Water | 548.60 |
| Anionic Dispersant | 66.03 |
| Orotan 731 (Rohm & Haas UK Ltd) | |
| Coalescent/Solvent | 30.13 |
| Benzyl Alcohol (Albright & Wilson UK) | |
| Sodium Carbonate Granular | 22.18 |
| (Sigma-Aldrich, Dorset UK) | |
| Propylene Glycol (1,2 Propane diol) | 3.13 |
| (Sigma-Aldrich, Dorset, UK) | |
| Antifoam/Defoamer | 9.95 |
| Dispelair CF616 (Blackburn Chemicals Ltd UK) | |
| Nonionic Ethoxylated Alcohol | 8.13 |
| Imbentin C135/150 (Libra Chemicals Ltd UK) | |
| Phenolsulfonepthalein Sodium Salt | 0.029 |
| Phenol Red (Fisher Scientific UK) | |

The following ingredients in Table XXXIII were then added to the paint formulation and the speed increased to 2000 rpm. Following the addition of these ingredients, the paint formulation was agitated for another 15 minutes.

TABLE XXXIII

| Component | Weight (grams) |
|---|---|
| Calcium Carbonate | 140.22 |
| Fordacal 30 (Fordamin Minerals UK) | |
| Hydrated Aluminum Silicate | 508.33 |
| China Clay Supreme (Imerys Minerals UK) | |
| Calcinated Diatomaceous Silica | 139.75 |
| Celite 281 (World Minerals UK) | |
| Rutile Titanium Dioxide | 632.55 |
| Tiona 595 (Millennium Chemicals UK) | |

The following components in Table XXXIV were then added to the paint formulation and the speed increased to 3000 rpm. Following the addition of these ingredients, the paint formulation was agitated for 25 minutes.

TABLE XXXIV

| Component | Weight (grams) |
|---|---|
| Urethane Rheology modifier | 55.45 |
| Acrysol RM8 (Rohm & Haas UK) | |

The following components in Table XXXV were then added to the paint formulation and the speed decreased to 2000 rpm. Following the addition of these ingredients, the paint formulation was agitated for a further 5 minutes.

TABLE XXXV

| Component | Weight (grams) |
|---|---|
| Biocide - Isothiazalone | 0.83 |
| Rocima V189 (Rohm & Haas UK) | |
| Tap Water | 82.74 |

The paint formulation was then allowed to cool for 30 minutes.

In the paint make-up stage, the following ingredients in Table XXXVI were added to a 2.5 litre stainless steel vessel prior to the addition of the components mixed during the grind stage. The contents were agitated using Heidolph paint stirrer and a 4″ blade at a speed of 250 rpm for 5 minutes.

TABLE XXXVI

| Component | Weight (grams) |
|---|---|
| Acrylic copolymer latex | 36.15 |
| Revacryl 1A (Harlow Chemical Co. UK) | |

2124.32 grams of grind mixture were then added to the ingredients shown in Table XXXVI with stirring and the contents agitated for a further 20 minutes at speed of 500 rpm.

The pH of the paint was 10.0.

The paint formulation was tested to determine the time required for a perceptible color change. To measure the time required for the paint formulation to change color, the paint was drawn down using a 400 micron block spreader on the unsealed back of a 3B Leneta Co. opacity chart. The color change time for the paint formulation was 60 minutes.

### Example 14

### Paint Formulation Without Humectant

The paint formulation of this example was prepared by adding the following components in Table XXXVII to a 2.5 Liter stainless steel dispersion vessel. In the grind stage, the following ingredients in Table 1 were added to the vessel in the same order as listed with the paint formulation being agitated with a high speed disperser (Dispermat MG-E7 from VMA Getzmann GMBH) fitted with a 100 mm cowles type blade operating at 1000 rpm.

TABLE XXXVII

| Component | Weight (grams) |
|---|---|
| Tap Water | 548.60 |
| Anionic Dispersant | 66.03 |
| Orotan 731 (Rohm & Haas UK Ltd) | |
| Coalescent/Solvent | 30.13 |
| Benzyl Alcohol (Albright & Wilson UK) | |
| Sodium Carbonate Grannular | 22.18 |
| (Sigma-Aldrich, Dorset UK) | |
| Tap Water | 3.13 |
| Antifoam/Defoamer | 9.95 |
| Dispelair CF616 (Blackburn Chemicals Ltd UK) | |
| Nonionic Ethoxylated Alcohol | 8.13 |
| Imbentin C135/150 (Libra Chemicals Ltd UK) | |
| Phenolsulfonepthalein Sodium Salt | 0.029 |
| Phenol Red (Fisher Scientific UK) | |

The following ingredients in Table XXXVIII were then added to the paint formulation and the speed increased to 2000 rpm. Following the addition of these ingredients, the paint formulation was agitated for another 15 minutes.

TABLE XXXVIII

| Component | Weight (grams) |
|---|---|
| Calcium Carbonate | 140.22 |
| Fordacal 30 (Fordamin Minerals UK) | |
| Hydrated Aluminum Silicate | 508.33 |
| China Clay Supreme (Imerys Minerals UK) | |
| Calcinated Diatomaceous Silica | 139.75 |
| Celite 281 (World Minerals UK) | |
| Rutile Titanium Dioxide | 632.55 |
| Tiona 595 (Millennium Chemicals UK) | |

The following components in Table XXXVIX were then added to the paint formulation and the speed increased to 3000 rpm. Following the addition of these ingredients, the paint formulation was agitated for 25 minutes.

TABLE XXXVIX

| Component | Weight (grams) |
|---|---|
| Urethane Rheology modifier | 55.45 |
| Acrysol RM8 (Rohm & Haas UK) | |

The following components in Table XL were then added to the paint formulation and the speed decreased to 2000 rpm. Following the addition of these ingredients, the paint formulation was agitated for a further 5 minutes.

TABLE XL

| Component | Weight (grams) |
|---|---|
| Biocide - Isothiazalone | 0.83 |
| Rocima V189 (Rohm & Haas UK) | |
| Tap Water | 82.74 |

The paint formulation was then allowed to cool for 30 minutes.

In the paint make-up stage, the following ingredients in Table XLI were added to a 2.5 litre stainless steel vessel prior to the addition of the components mixed during the grind stage. The contents were agitated using Heidolph paint stirrer and a 4″ blade at a speed of 250 rpm for 5 minutes.

TABLE XLI

| Component | Weight (grams) |
|---|---|
| Acrylic copolymer latex | 36.15 |
| Revacryl 1A (Harlow Chemical Co UK) | |

2124.32 grams of grind mixture were then added to the ingredients shown in Table V with stirring and the contents agitated for a further 20 minutes at a speed of 500 rpm.

The pH of the paint was 10.0

The paint formulation was tested to determine the time required for a perceptible color change. To measure the time required for the paint formulation to change color, the paint was drawn down using a 400 micron block spreader on the unsealed back of a 3B Leneta Co. opacity chart. The color change time for the paint formulation was 45 minutes.

What we claim is:

1. A water borne latex pink colored paint composition comprising:
a) a color change additive selected from phenol red, and alkali metal or alkaline earth metal salts of phenolsulfone phthalein, and mixtures of one or more thereof with other color change additives in an amount of not greater than 0.003 weight percent of the aqueous borne paint composition; and
b) from about 0.001 to about 1.5% by weight of at least one amine having a boiling point above about 100° C.;
wherein the paint composition has a pH of less than about 10.5 and a viscosity of less than about 65,000 centipoise and dries to a white colored film.

2. An architectural substrate comprising a painted multicolored topcoat all from the same coating composition where the color ranges from pink for the wet painted surface to white for the dried painted surface and pink changing to white for the surface that has started to dry.

3. The substrate of claim 2 wherein the substrate is selected from walls, trim, clapboard, siding, window frames, ceilings, or gypsum board.
